(19) United States
(12) Patent Application Publication
(10) Pub. No.: US 2025/0029063 A1
(43) Pub. Date: Jan. 23, 2025

(54) ARTIFICIAL INTELLIGENCE-BASED PROFESSIONAL HUMAN RESOURCE PLATFORM SERVICE METHOD CAPABLE OF PROVIDING NON-FACE-TO-FACE RECRUITMENT SERVICES

(71) Applicant: Bluevisor Systems, Busan (KR)

(72) Inventors: Yong-guk HWANG, Busan (KR); Eun-a LEE, Busan (KR); Geongi IM, Busan (KR)

(21) Appl. No.: 17/982,630

(22) Filed: Nov. 8, 2022

(30) Foreign Application Priority Data
Oct. 13, 2022 (KR) 10-2022-0131236

(51) Int. Cl. G06Q 10/10; G06Q 10/06; G10L 15/18

(52) U.S. Cl. CPC G06Q 10/1053; G06Q 10/063112; G10L 15/18

(57) ABSTRACT

An artificial intelligence-based professional human resource platform service method that provides non-face-to-face recruitment services is provided. Interview practice skills can be improved through the analysis of artificial intelligence and the provision of job-specific questions, and an additional job opportunity can be provided through the offer of an interview when a registration is made for an interview.

### CROSS-REFERENCE TO RELATED APPLICATION

This application claims priority from Korean Application No. 10-2022-0131236 filed on Oct. 13, 2022, which is incorporated herein by reference in its entirety.

### BACKGROUND

### 1. Technical Field

The present disclosure described herein relates to an artificial intelligence-based professional human resource platform service method that provides non-face-to-face recruitment services.

### 2. Description of the Related Art

Unless otherwise indicated herein, the items described in this section do not correspond to prior art to the claims of this application, and the inclusion of an item in this section is not an admission that it is prior art.

In general, in recent years, recruiters can perform their recruitment tasks more rapidly and easily, and desire to recruit talent based on a larger amount of data by objectifying what previously had to rely on subjective judgment.

However, a large number of applicants, e.g., an average of about 250 applicants, apply to one job posting, and it takes enormous time and cost to process collected recruitment data.

Accordingly, it is necessary to rapidly analyze the histories and the like of applicants.

For example, such applicants will be able to smoothly and stably conduct interviews at high speed anywhere regardless of time by installing an application on their personal smartphones.

In addition, personal recruitment management may be easily performed by smoothly using the unique functions of a smartphone such as a calendar, an address book, and a camera within the smartphone.

Furthermore, on the other hand, the existing recruitment decision making depends only on hard skills, and thus the width of the basis for the recruitment decision making is narrowed, so that whether to recruit an applicant can be determined based on a wider range of data by providing a tool for measuring these items.

However, the conventional art does not provide a proactive direct sourcing function and soft skill evaluation function that can overcome the above problems. Accordingly, it is necessary to provide recruitment-related functions, such as a screening/filtering function, an applicant tracking/relationship management function, and a video interview generation and sharing function.

A prior art document satisfying this need is the following document.
(Patent document 1) KR1022811610 Y1

For reference, the technology of patent document 1 relates to a non-face-to-face interview, and is configured to construct interview questions based on a self-introduction letter and then provide a service to an interviewer's terminal.

### SUMMARY

The present disclosure intends to provide an artificial intelligence-based professional human resource platform service method capable of providing non-face-to-face recruitment services that allows interview practice skills to be improved through the analysis of artificial intelligence and the provision of job-specific questions and enables customized talent to be recruited in a non-face-to-face manner by analyzing the interview videos of applicants using algorithms such as artificial intelligence (AI) image and speech analysis algorithms.

According to an aspect of the present invention, there is provided an artificial intelligence-based professional human resource platform service method capable of providing a non-face-to-face recruitment service, the artificial intelligence-based professional human resource platform service method including: analyzing and processing skills and history of an applicant who applies for a job posting, and then visualizing and providing results of the analysis and the processing; conducting an artificial intelligence interview for the applicant; analyzing an interview video of the applicant by using artificial intelligence image and speech analysis algorithms; measuring an artificial intelligence interview score of the applicant; and analyzing images, voices, and attitudes in the interview video of the applicant and providing an artificial intelligence analysis report.

Analyzing and processing the skills and the history and then visualizing and providing the results of the analysis and the processing may include determining whether a document has passed or sorting the document according to its rank by tracking a text of a resume of the applicant and then performing filtering and weighting according to specifications desired by a company through artificial intelligence.

Conducting the artificial intelligence interview may include providing a job-specific interview question template that can be referenced or utilized for the interview questions.

Conducting the artificial intelligence interview may include conducting tests specialized for a job group for which hard skills are important.

Analyzing the interview video of the applicant may include constructing additional interactive questions by analyzing the real-time interview content of the applicant through voice recognition.

Analyzing the interview video of the applicant may include processing and analyzing audio data in real time by performing speaking speed detection, used word analysis, and dialect recognition for the applicant.

Analyzing the interview video of the applicant may include performing language analysis, including words and sentences, and positive and negative semantic analysis in the interview video of the applicant.

Analyzing the interview video of the applicant may include analyzing facial expressions and eye tremors through the recognition of the facial muscles of the applicant, and determining the tension level of the applicant by detecting subtle changes in skin tone

Measuring the artificial intelligence interview score of the applicant may include measuring the artificial intelligence interview score by combining the results of learning interviewer patterns from various viewpoints similar to those of actual interviews.

In order to predict interview scores in the same manner as those of actual interviews, weights are allocated to the necessary aptitude for the job, an appropriate interviewer's score, and an evaluation value that fits the view of talent of the company.

The artificial intelligence-based professional human resource platform service method may further include, after Analyzing the images, the voices and the attitudes and providing the artificial intelligence analysis report, tracking the applicant and managing the applicant in an integrated manner through an overall recruitment process including a job posting, a conduct of an interview, an address book, and notification of interview results.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram conceptually illustrating a non-face-to-face interview method through data processing according to an embodiment;

FIG. 2 is a diagram showing an overall system applied to a non-face-to-face interview method through data processing according to an embodiment;

FIG. 3 is a block diagram showing the configuration of the management information processing apparatus to which a non-face-to-face interview method through data processing according to an embodiment is applied;

FIG. 4 is a flowchart sequentially showing a non-face-to-face interview method through data processing according to an embodiment;

FIG. 5 is a diagram illustrating proactive direct sourcing applied to a non-face-to-face interview method through data processing according to an embodiment;

FIGS. 6A and 6B are flowcharts illustrating applicant screening and filtering applied to a non-face-to-face interview method through data processing according to an embodiment;

FIG. 7 is a diagram illustrating a data operation process applied to a non-face-to-face interview method through data processing according to an embodiment;

FIG. 8 is a view showing a user interface (UI) screen for an interviewee applied to a non-face-to-face interview method through data processing according to an embodiment;

FIG. 9 is a view showing a UI screen for an interviewer applied to a non-face-to-face interview method through data processing according to an embodiment;

FIG. 10 is a diagram showing an example of interviewee face detection, natural language and voice processing, recognition/speech synthesis:

FIG. 11 is a diagram showing an example of an artificial intelligence interview service;

FIG. 12 shows views illustrating examples of AI-based non-face-to-face recruitment platform images for an interviewee and an interviewer;

FIG. 13 is a diagram illustrating a client-server configuration for non-face-to-face customized talent sourcing through artificial intelligence analysis; and

FIG. 14 is a diagram illustrating an example of an interface configuration for non-face-to-face customized talent sourcing service.

### DETAILED DESCRIPTION

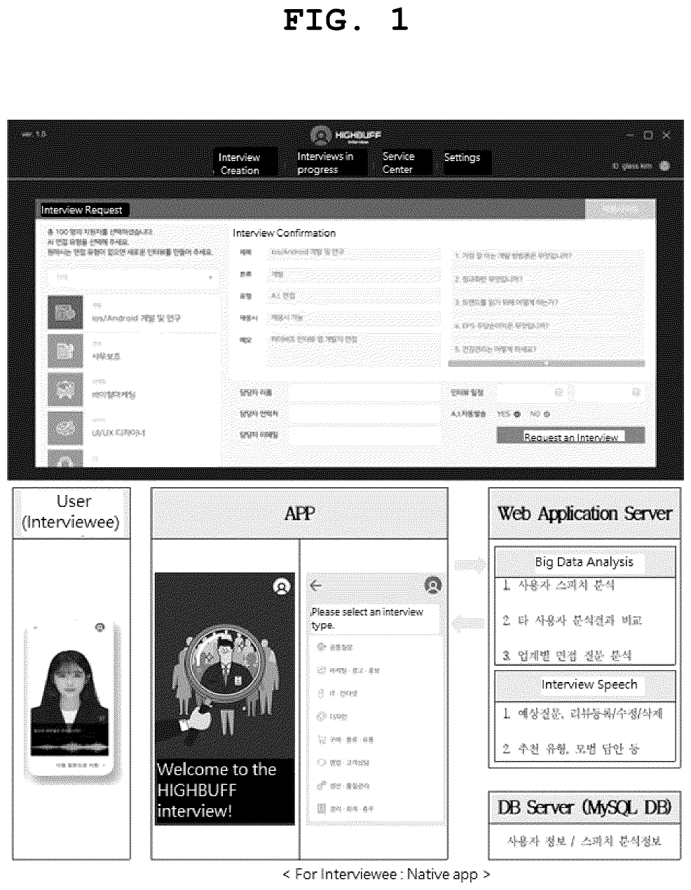

FIG. 1 is a diagram conceptually illustrating a non-face-to-face interview method through data processing according to an embodiment.

As shown in FIG. 1, the non-face-to-face interview method through data processing according to the present embodiment helps recruiters to more easily access and utilize vast amounts of recruitment data when various companies provide recruitment services for various types of jobs.

More specifically, the non-face-to-face interview method through data processing is performed as follows:

First of all, this non-face-to-face interview method provides the service of allowing an interviewee to take a non-face-to-face interview, to check interview results, to select the type of non-face-to-face interview, and to easily respond to interview questions as services for an interviewee through a mobile terminal (Native App).

Furthermore, in this case, a simulated interview service is provided through a video interview of a specific personal version (for the interviewer) in advance.

In this case, in the case of such simulated interviews, the types of interviews may be classified into common questions, marketing, advertising, public relations, IT, Internet, design, purchasing, logistics, distribution, sales, customer consultation, production, and quality management.

In addition, for example, when an interviewee downloads the personal version on his or her smartphone or the like and enters a code, he or she may easily take an interview. Furthermore, after relaxing using a pre-mouth warm-up test and a speed game, an interviewee selects a desired job and answers self-introduction and questions.

Thereafter, in addition to this, the non-face-to-face interview method provides a different code for each company, checks data on applicants for each job group, and provides a report such as interview results, and interview data for an interviewer (PC (SW)).

Furthermore, in this case, in particular, through the video interview of a company version (for an interviewer), questions may be customized to meet a view on talent desired for a company by freely setting questions that fit job competency.

For example, a comprehensive report obtained by analyzing video and audio data for each interviewee is provided, interviewees are quantitatively compared with each other at a glance, and the data of the applicants may be checked on a per-recruitment unit basis in one place. Accordingly, successful candidates may be determined more rapidly and accurately.

In addition, the non-face-to-face interview method provides a tool for measuring the soft skills of applicants, so that whether to recruit applicants is determined based on a wider range of data. Furthermore, a recruiter may check the applicants' data via a report in a dashboard form, and the applicants may also check their evaluation results in the form of a report, so that they may perform reasonable recruit decision making. Moreover, objective decision making is performed based on data through non-face-to-face hard skill tests and soft skill tests.

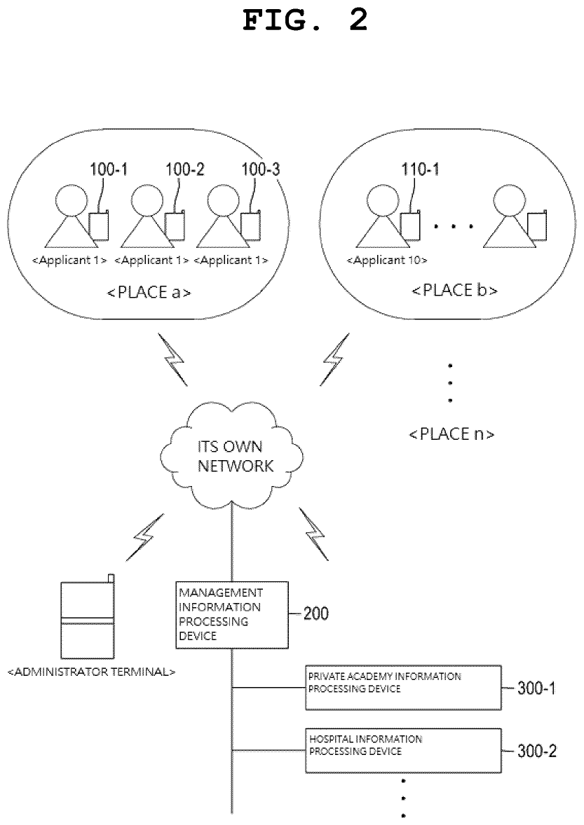

FIG. 2 is a diagram showing an overall system applied to a non-face-to-face interview method through data processing according to an embodiment.

As shown in FIG. 2, the system of the present embodiment includes: mobile terminals 100 and 110 carried by a number of different (preliminary) applicants in various places; and a management information processing device 200 (including an administrator terminal 210) configured to collect data on the applicants and conduct a non-face-to-face interview.

Additionally, the system according to the present embodiment includes a private academy information processing device 300-1, a hospital information processing device (for health diagnosis) 300-2, and a clothing, hair, etc. information processing device (not shown) in order to connect the management information processing device 200 with the outside.

In addition, in the system, the above-described devices are then connected via the system's own network. For example, Wi-Fi or LTE is used as a wireless communication method, a wireless method (LORA, RF, BT, or BLE) is used to connect with the adjacent administrator terminal 210, and devices connected by a wired method are connected using a serial method (RS232, or RS485).

The mobile terminals 100 and 110 are carried by a number of different (preliminary) applicants in various places a, b, . . . , and n, and allow each applicant to take an interview, to check interview results and to easily answer interview questions via the services for an interviewer (Native App). Furthermore, the mobile terminals 100 and 110 provide a simulated interview service through video interview of a specific personal version (for an interviewee) in advance. In this case, the mobile terminals 100 and 110 help each interviewee to select the type of interview, and also help (preliminary) applicants to easily and conveniently take interviews or preliminary interviews.

The management information processing device 200 provides different codes for a plurality of respective different companies, checks data on applicants for each job group, and provides reports, such as interview results, and interview data via the services for an interviewer (PC (SW)). Furthermore, in this case, the management information processing device 200 customizes questions to meet a view on talent to be found by freely setting the questions appropriate to the job competency particularly through a video interview of a company version (for an interviewer). To this end, proactive direct sourcing is offered by, e.g., customizing applicant criteria, including a skillset, experience and aptitude (a detailed description thereof will be given below). Additionally, whether to recruit applicants may be determined based on a wider range of data by providing a tool for measuring the soft skills of the applicants, and also objective data-based decision making is provided through non-face-to-face hard skill tests and soft skill tests.

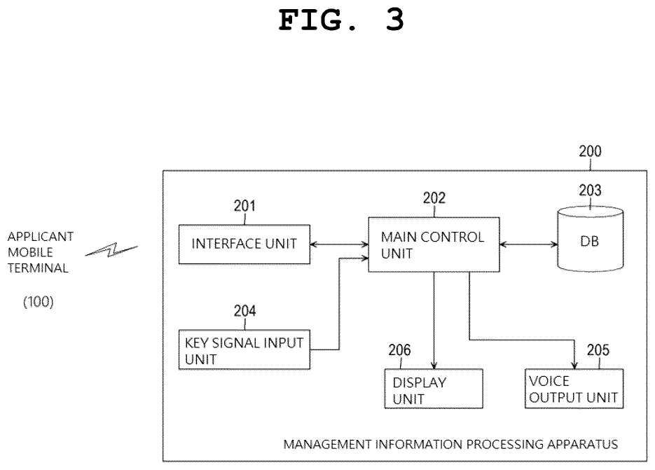

FIG. 3 is a block diagram showing the configuration of the management information processing apparatus to which a non-face-to-face interview method through data processing according to an embodiment is applied.

As shown in FIG. 3, the management information processing apparatus 200 according to the present embodiment includes: an interface unit 201 configured to connect with the (preliminary) applicants' mobile terminals 100; a main control unit 202 configured to receive applicant data from the applicant mobile terminals 100 and perform a job posting/non-face-to-face interviews; and a database 203 related thereto.

Additionally, the management information processing apparatus 200 according to the present embodiment further includes a key signal input unit 204 configured to receive various types of setting information related to a non-face-to-face interview according to user key operations, a voice output unit 205 configured to output various service voices, and a display unit 206 configured to display various types of service user interfaces (UIs).

The interface unit 201 is connected to the (preliminary) applicants' mobile terminals, receives data on the applicants, interview information and/or preliminary interview information, and provides recommended information and model answers for various interviews, actual interview information, preliminary interview information, etc. For example, it is connected using Wi-Fi or LTE, or is also connected to the administrator terminal or the like through wireless (LORA, RF, BT, or BLE).

The main control unit 202 receives applicant data from a plurality of different applicant mobile terminals in batches and performs job posting/non-face-to-face (preliminary) interviews. For example, the main control unit 202 provides different codes for a plurality of respective different companies, collects and checks data on applicants for each job group, and provides reports, such as interview results, and interview data. Furthermore, in this case, the main control unit 202 provides a comprehensive report obtained by analyzing the video and audio data for each interviewee, provides a service for quantitatively comparing interviewees at a glance, and checks applicant data for each recruitment unit in one place, thereby determining successful applicants more rapidly and accurately.

The database 203 registers and manages the user information and speech analysis information of (preliminary) applicants under the control of the main control unit 202 in the case of such a non-face-to-face interview.

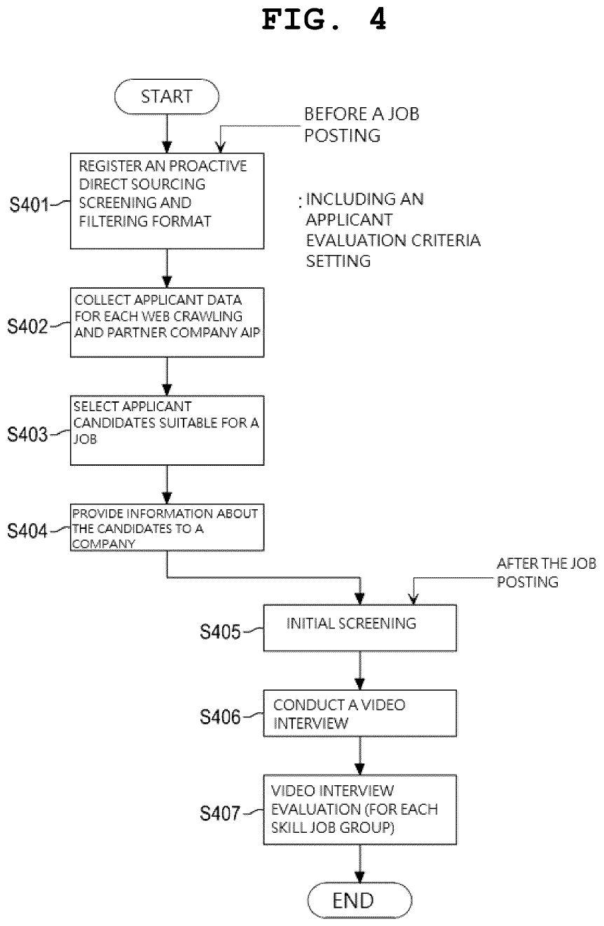

FIG. 4 is a flowchart sequentially showing a non-face-to-face interview method through data processing according to an embodiment (see FIG. 3).

As shown in FIG. 4, in the non-face-to-face interview method through data processing according to the present embodiment, it is assumed that, when each company recruits persons for a job, the management information processing device collects data on applicants and provides a recruitment service (which corresponds to the prior art).

A) In this state, in the non-face-to-face interview method, first, before a job posting for the above recruitment service, a screening/filtering format for proactive direct sourcing is set by customizing candidate evaluation criteria including a skillset, experience, and knowledge for each different company and job at step S401.

In addition, in this case, the candidate evaluation criteria is classified into essential elements (must-have) and optional elements (nice-to-have) based on job description templates for each of a number of different job groups/each of jobs and is then set up. In this case, scoring customization is also provided by differentially assigning scores to individual skills.

B) Thereafter, data on applicants (preliminary) is collected from multiple locations, in which case big data on the (preliminary) applicants is collected for each of the Application Programming Interfaces (APIs) of a number of different web crawling and recruitment partners at step S402. Thereafter, applicants with job suitability are selected as candidates according to a proactive direct sourcing screening/filtering format at step S403, and information about the candidates is provided as a service to each company at step S404.

Additionally, in this case, the proactive direct sourcing screening/filtering format is as follows.

a) In other words, this format is used to first collect (preliminary) applicant data for each of the APIs of the web crawling and recruitment partners, applicant data for each job posting, and applicant data for each video interview, to receive (preliminary) applicant data, and to analyze the types of data.

b) In addition, when such data is received, it is classified into structured data including (preliminary) applicants' grades and names and unstructured data including emotional levels and passions, the structured data is text indexed and the unstructured data is separated and extracted into text-based data and moving image data, and the applicants' recruitment data is analyzed using the framework (SyntaxNet) and GrabCut of a syntax analyzer for each piece of different data.

c) Accordingly, through this, the recruitment data information of the applicant is visualized by processing the recruitment data into aggressiveness data, safety data, reliability data, positivity data, responsiveness data, data, and attractiveness data willpower data, activity according to the recruiting criteria applicant screening and filtering format.

C) Meanwhile, in this non-face-to-face interview method, after the job posting, the resumes and self-introductions of the applicants are analyzed and classified through a set natural language processing engine, and then scored, and job suitability is detected by comparing the match rates between the stored data and the job posting, thereby performing initial screening at step S405.

D) Furthermore, also, after the above initial screening, video interview information having elements including the types of questions and answer periods of time is generated for each job for each company at step S406. Furthermore, when such video interview questions are constructed, a video interview question template is prepared by creating an interview question template.

E) Accordingly, the video interview is evaluated by the image recognition and speech analysis of the video interview at step S407. Skills are differentially compared and analyzed for a job group for hard skills including developers, data analysts and designers and for a job group for soft skills requiring collaboration, organizational culture suitability, and time management.

As described above, in the present embodiment, as the services for an interviewee using a mobile terminal (Native App), a non-face-to-face interview may be taken, interview results may be checked, the type of non-face-to-face interview may be selected, and interview questions may be easily answered.

In addition, in this case, a simulated interview service is provided through a video interview of a specific personal version (for an interviewee) in advance.

In addition to this, as services for an interviewer using a PC (SW), different codes for non-face-to-face interviews are provided for respective companies, data on applicants is collected and checked for various job groups, and reports, such as results related to this interview, and interview data are provided.

Furthermore, through the video interview of a company version (for an interviewer), questions may be customized to meet a view on desirable talent required for a company by freely setting questions that fit job competency.

Additionally, whether to recruit applicants may be determined based on a wider range of data by providing a tool for measuring the soft skills of the applicants, and also objective data-based decision making is provided through non-face-to-face hard skill tests and soft skill tests.

Therefore, through this, experts necessary for companies may be efficiently recruited, so that companies can focus on their core business.

In addition, numerous application documents may also be screened in a consistent and objective manner, and the diversity of talent pools in which companies can be interested are highly expanded in the task of collecting and selecting talent. As a result, talented people with excellent competencies may be recruited.

In addition, fair recruitment may be performed by making sure that a recruitment process is performed without unfair practices in which a recruiting administrator manipulates an applicant's recruitment score or gives additional points during an interview process.

In addition, after an interview is over, it may be impossible to determine a successful candidate based on false results different from genuine interview results in such a manner that an HR team revises an interview evaluation sheet prepared by an interviewer or writes a written summary of the interview result in a false way, so that fair recruitment can be performed.

Meanwhile, in addition, this non-face-to-face interview method allows applicants to take interviews more conveniently by providing the following additional services to (preliminary) applicants in the case of such non-face-to-face interviews.

A) For this purpose, in this non-face-to-face interview method, when the above-described recruitment service and video interview are evaluated, (expected) interview information for a plurality of different (preliminary) applicants are received from (preliminary) the applicants' mobile terminals for different types of interviews in batches and then big data is analyzed. Thereafter, user speech analysis and user analysis results are compared for various users by using this information, interview question information is analysis provided for each company, and interview results are returned.

B) In addition, based on this analysis information, interview speech information including recommended types, model answers, and expected questions is calculated and provided for each interview type for each company.

C) In addition, in the case of an (expected) interview, user information and speech analysis information about (preliminary) applicants are classified into different individual versions, registered, and then managed.

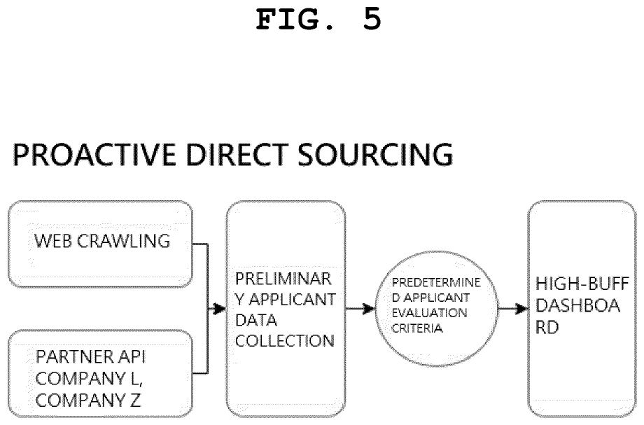

FIG. 5 is a diagram illustrating proactive direct sourcing applied to a non-face-to-face interview method through data processing according to an embodiment.

As shown in FIG. 5, the proactive direct sourcing according to the embodiment provides services to several companies before a job posting, as described above.

More specifically, it is as follows:

### Before a Job Posting

### 1) Candidate Criteria Customization

A) Recruiter—enhances the job suitability of (preliminary) applicants by specifying a skillset, experience, and knowledge required for a corresponding job

B) Applicants—are able to actively participate in the recruitment process by making applications after clearly understanding a company and a job

### 2) Provision of Job Description Template

A) A job description and a job posting preparation template for each job group/job are provided.

B) A job posting may be prepared with elements classified into essential (must-have) elements and optional (nice-to-have) elements. In particular, in the case of a premium rate plan, it may be possible to customize scoring in such a manner that a recruiter differentially assigns scores to individual skills.

### 3) Proactive Direct Sourcing

A) The applicants' big data is collected through web crawling and recruitment platform partnerships.

B) Thereafter, the collected big data is processed through a screening/filtering algorithm, and applicants with optimal job suitability are selected as candidates.

C) When necessary, a recruitment process is expedited by sending e-mails to the applicants and offering video interviews to the applicants.

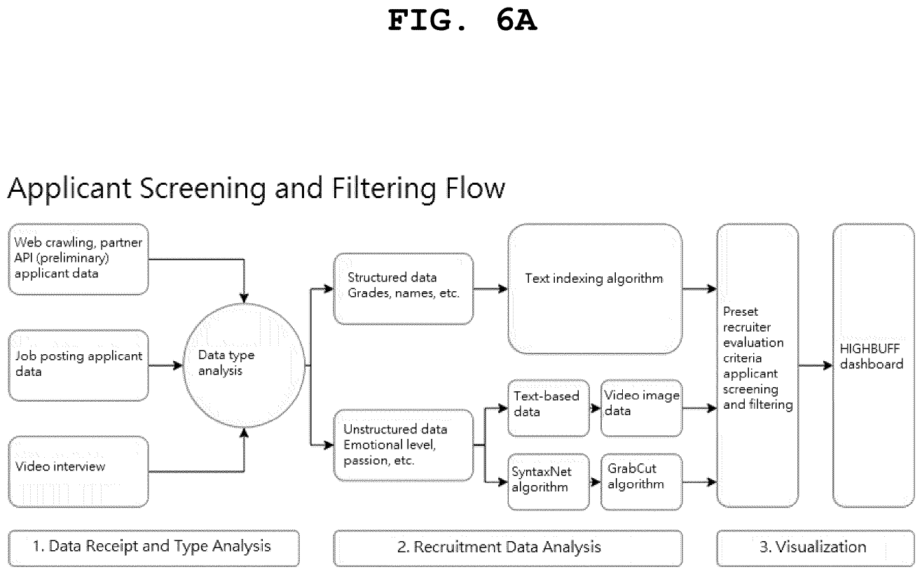

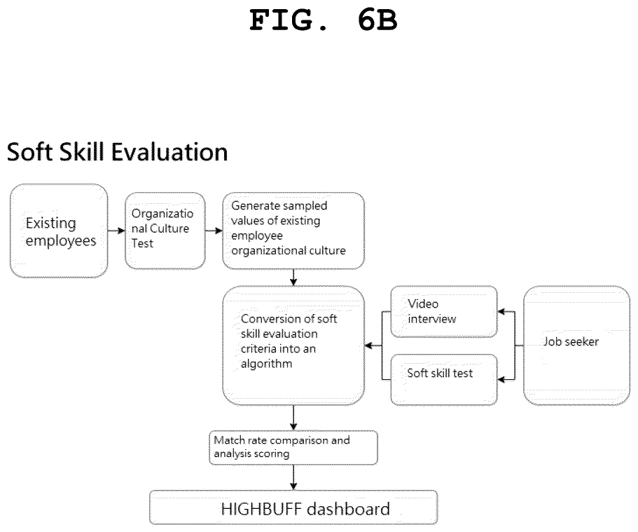

FIGS. 6A and 6B are flowcharts illustrating applicant screening and filtering applied to a non-face-to-face interview method through data processing according to an embodiment.

As shown in FIGS. 6A and 6B, the applicant screening and filtering according to an embodiment provides services suitable for various companies after a job posting.

More specifically, it is as follows:

### After a Job Posting

### 1) Initial Screening

A) Resumes and self-introductions are analyzed and classified through a natural language processing engine and then scored.

B) Job suitability may be expressed numerically by comparing the rates of match with the job posting, and may be rapidly checked.

### 2) Video Interview Making

A) Various elements such as the type of questions and answer times may be freely set.

### 3) Provision of Video Interview Question Template

A) A job-specific interview question template that can be referenced or utilized when video interview questions are planned is provided.

### 4) Video Interview Scoring

A) The video interviews of the applicants are analyzed using algorithms such as artificial intelligence image recognition and speech analysis algorithms.

### 5) Hard Skillset Test

A) Specialized tests suitable for a job group for which hard skills are important, including developers, data analysts, designers, etc., are conducted.

### 6) Soft Skillset Test

A) An effective algorithm is provided for evaluating hard-to-expect soft skills collaboration, such as organizational culture suitability, and time management.

B) In particular, in the case of an organizational culture suitability test, a company selects its own evaluation criteria and compares and analyzes the data of existing employees and applicants, such as data on disposition and culture, by using the data of the existing employees.

### General Functions

### 1) Talent Dashboard

A) There is provided a dashboard that visualizes the skillsets and careers of both the prospective applicants extracted through a direct sourcing function and the applicants introduced through a job posting.

B) Data-based decision making is enabled by easily utilizing and analyzing vast amounts of recruitment data.

### 2) Applicant Tracking System

A) Applicants can be tracked throughout an overall recruitment process, including a job posting, the arrangement of an address book, email contacts, the conduct of interviews, and the sharing of interview results.

### 3) Collaborative Workspace

A) Administrator rights to allow multiple team members to work simultaneously are granted.

B) Comments can be posted for each applicant's materials such as a video, a resume, and a skillset test.

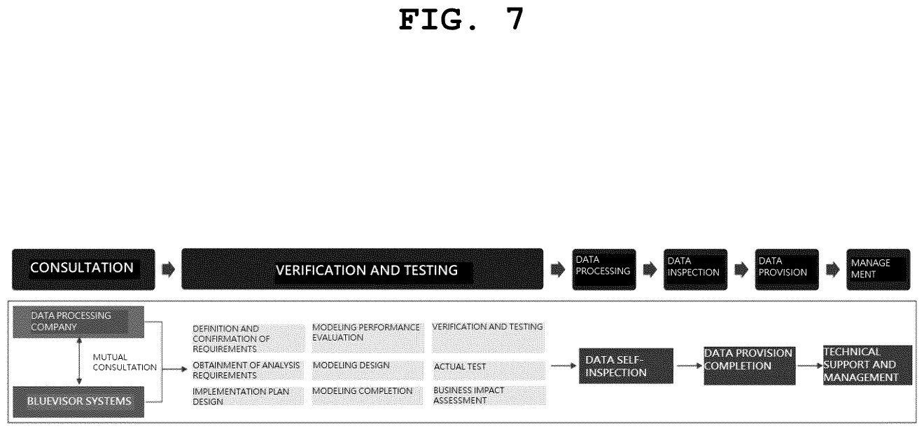

FIG. 7 is a diagram illustrating a data operation process applied to a non-face-to-face interview method through data processing according to an embodiment.

As shown in FIG. 7, the data operation process according to the present embodiment is performed using detailed information of a processing service as follows:

\textcircled{1} In other words, a business agreement is concluded through mutual consultation via consultation first.

\textcircled{2} Next, the deduction of analysis requirements for the definitions and confirmation of requirements and the design of an implementation plan are carried out.

\textcircled{3} Thereafter, for modeling performance evaluation, modeling is completed by designing modeling through mutual collaboration.

\textcircled{4} Then, the verification of the modeling is completed by actually testing the completed modeling and evaluating the impact thereof on business.

\textcircled{5} Processed data is self-inspected.

\textcircled{6} Inspection completion data is provided.

\textcircled{7} Therefore, continuous follow-up management is provided by supporting and managing the service technology of the company.

FIG. 8 is a view showing a UI screen for an interviewee applied to a non-face-to-face interview method through data processing according to an embodiment.

As shown in FIG. 8, the UI screen for an interviewee according to the present embodiment provides, e.g., the service of taking a non-face-to-face interview and checking interview results. In addition, a UI screen for selecting the type of interview is provided. In this case, the types of interviews may include common questions, marketing, advertising, public relations, IT, Internet, and design. Also, a UI screen that can respond to interview questions and a UI screen that is related to interview questions for each job group are provided.

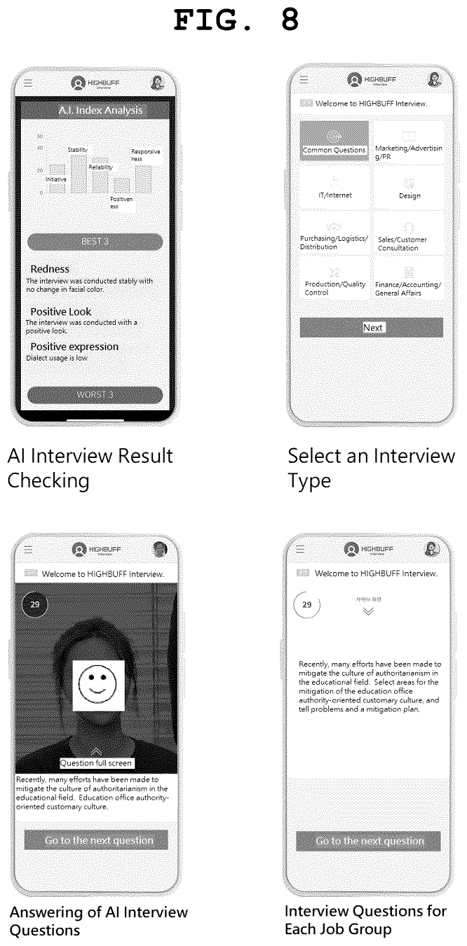

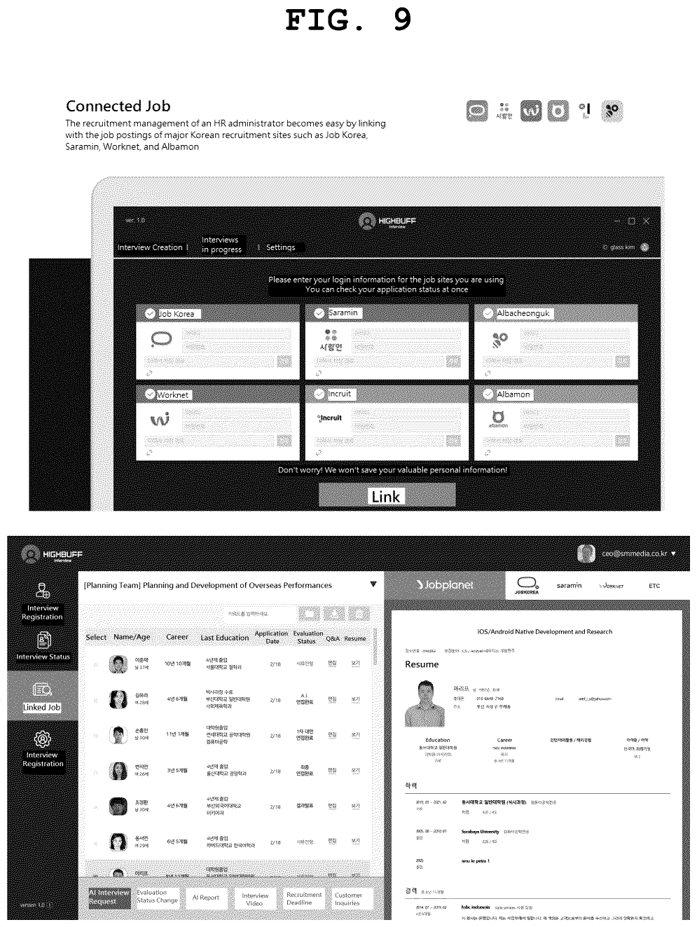

FIG. 9 is a view showing a UI screen for an interviewer applied to a non-face-to-face interview method through data processing according to an embodiment.

As shown in FIG. 9, the UI screen for an interviewer according to the present embodiment provides, e.g., a UI screen for providing codes for respective companies, a UI screen for checking applicant data for each job group, and a UI screen for providing reports, such as non-face-to-face interview results, and interview data as the main functions (services) thereof.

Meanwhile, additionally, in the non-face-to-face interview method through data processing, when recruitment services are provided through the manager terminal as described above, a database is matched to the administrator terminal in real time and a connection is secured, so that real information can be delivered to the administrator rapidly and easily.

To this end, the main control unit performs the following operations:

A) First, in order to match a database, when recruitment services are provided, the same table storing the device registration information and data of the management information processing device is equally provided as in an applicant's mobile terminal, and the matching relationship with the table is set and registered in advance.

B) When the content is changed in the table, this changed table is synchronized with the table of the counterpart according to the matching relationship.

C) Furthermore, when the tables are synchronized with each other, databases are matched with each other in real time by performing the synchronization with content diversified for each type of data for each type of recruitment services (or functions).

A) Next, in this case, in order to secure a connection with the administrator terminal, it is first checked whether a registered local communication network is connected. When, as a result of the checking, it is determined that the local communication network is connected, a connection is set up using a set administrator common account corresponding to each different management work location.

B) When, as a result of the checking, it is determined that the local communication network is not connected, it is secondarily checked whether a registered wireless communication network is connected.

C) When, as a result of the above checking, it is determined that the wireless communication network is connected, a connection is made with an individual IP address.

In contrast, when the wireless communication network is not connected, a connection is made with the terminal identification number of the registered mobile communication network, so that a real-time connection with the manager terminal is set up.

Meanwhile, when a real-time connection is made with the administrator terminal in this manner, an IP table is used to monitor a registered IP and to manage monitoring (or a log) based on the access of the unauthorized person for the security of the connection.

A) More specifically, for this purpose, an IP table in which an administrator public account of the local communication network and individual IP (Internet Protocol) addresses of the wireless communication network are registered is constructed in advance.

B) Furthermore, when an alarm is provided to the administrator terminal in this manner, a next hop switch IP address is extracted from response results by sending a HELLO message of the corresponding communication network.

C) Thereafter, it is checked whether a switch IP address identical to the next hop switch IP address is present in a switch neighbor connection relationship list.

D) When, as a result of the checking, it is determined that a switch IP address identical to the next hop switch IP address is present, it is checked whether an unauthorized person has access by checking whether a corresponding administrator public account or an individual IP address is also in the IP table.

E) When, as a result of the checking, it is determined that the corresponding administrator public account or individual IP address is also present in the IP table, a connection is made with the corresponding communication network by sending a JOIN/PRUNE message.

Meanwhile, in the non-face-to-face interview method, when the recruitment services are provided as described above, information about applicants is learned from a structure below, and a recommended type, etc. are smoothly provided.

In other words, additionally, in the non-face-to-face interview method, a learning model for monitoring is generated by taking into consideration actual surrounding states or situations such as structured data including grades and names and unstructured data including emotional levels and passions, so that desirable services can be provided.

In this case, the learning model classifies data into attributes based on various places (e.g., a place of completion, etc.) and time spans (e.g., a time of completion, etc.), so that the processing rate is further increased.

a) First, purpose, for example, when a for this recommended type for an interview is provided, there is defined a model information, including actual that classifies surrounding states or situations, such as structured data including grades and names, and unstructured data including emotional levels and passions, according to time spans and places, and learns the classified information.

b) Thereafter, basic datasets for a number of different pieces of surrounding state or situation information are extracted.

c) Then, these datasets are converted into attributes based on a number of different places and time spans.

d) Accordingly, the attributes of the state information are determined for each of a number of different learning models based on the results of the conversion into the attributes.

e) Then, the results of the determination are normalized.

f) Furthermore, based on the results of the normalization, state information is set for each of a number of different learning models. Accordingly, it is set as independent (a recommended type) and dependent (surrounding state/situation information) variables for generating information that provides a recommendation type for an interview using a plurality of different pieces of surrounding state/situation information.

g) Thereafter, the results of the setting are generated as learning and training data.

h) Accordingly, through this, a deep learning-based learning model for monitoring is constructed from these results.

Therefore, this non-face-to-face interview method provides practically helpful services because, when the recruitment services are provided as described above, a recommended type regarding an interview is provided from the above-described details.

In other words, as described above, this non-face-to-face interview method smoothly provides a recommended type and/or the like by learning information about an applicant from the following configuration when providing the recruitment services according to the above-described embodiment.

In addition, in this non-face-to-face interview method, a learning model for monitoring is constructed by taking into consideration actual surrounding states or situations such as structured data including grades and names and unstructured data including emotional levels and passions, and then desired services are provided.

Additionally, the non-face-to-face interview method according to the present embodiment will be described using this method (a description of the operation).

a) First, using this configuration, services such as the evaluation of a video interview are provided. In this case, a plurality of different pieces of per-(preliminary) applicant (expected) interview information are received for each interview type for each different company from the (preliminary) applicant mobile terminals in batches.

b) Accordingly, when such a request is received, from the above configuration, interview speech information including a recommended type, model answers, and expected questions is extracted and provided for each interview type for each different company.

Meanwhile, in this case, the above configuration analyzes big data on the interview information for each interview type, compares user speech analysis results with other user analysis results, and calculates and provides interview question analysis information for each company.

c) Then, when such a (predicted) interview is conducted, individual pieces of user information and speech analysis information about the (preliminary) applicant classified into different individual versions, and then registered and managed.

Additionally, a method of constructing the above learning model will be described in more detail.

First, such learning models are constructed with datasets classified because patterns vary depending on a number of different places, time spans, and periods. Accordingly, each model may be newly constructed, or a model including a bundle of models may be constructed based on a set criterion. This allows an appropriate method to be determined according to the characteristics of data.

Thereafter, in the case where a large amount of data is not collected due to errors in collected data or an outlier including an unusually large number of reservations occurs, a corresponding data file is removed.

In addition, when partial data is not collected due to an occasional data interruption, corresponding data is removed.

Thereafter, valid attributes are determined for different models, normal values are generated, and then independent and dependent variables are determined.

Thereafter, in order to generate a learning model, learning and training data are generated from overall data. In general, 70% of an overall dataset is used as learning data, and 30% thereof is used as training data to test a model after the construction of the model.

Thereafter, a learning model is constructed. At this stage, it is determined what type of learning model will be used. For example, necessary layers are constructed based on deep learning, input and output layers are constructed, and then the maximum number of outputs are set. Then, the generated model is evaluated. When this model satisfies the error rate, the model is simulated with new data. When the update of the model is not required, the learning model is stored and used as a predictive model.

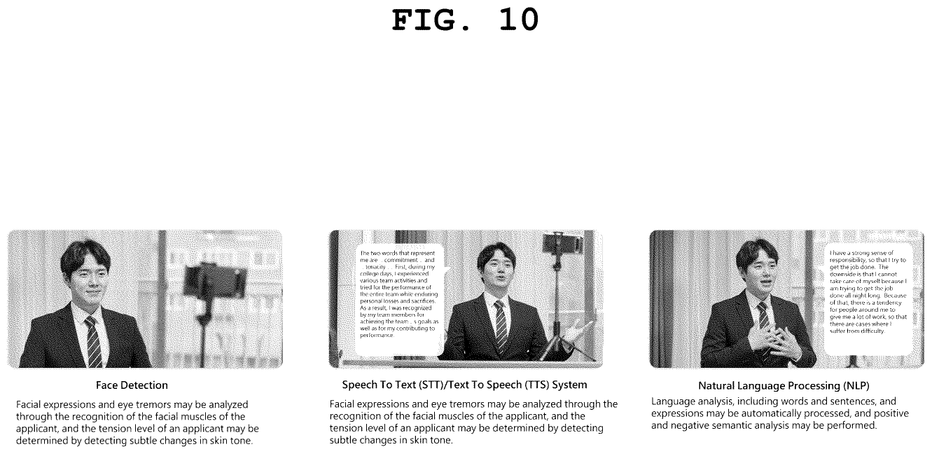

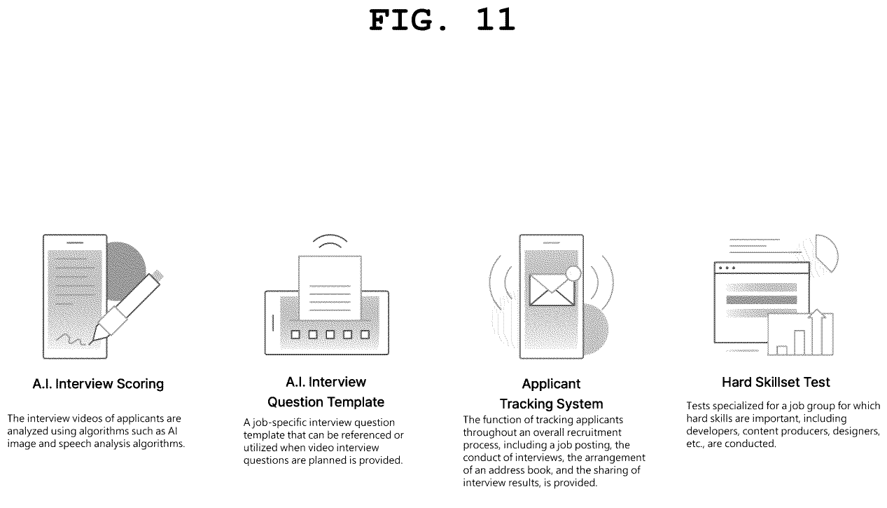

FIG. 10 is a diagram showing an example of interviewee language processing, and voice face detection, natural recognition/speech synthesis, and FIG. 11 is a diagram showing an example of an artificial intelligence interview service.

As shown in the drawing, a Speech To Text (STT)/Text To Speech (TTS) system enables the real-time processing of an interviewee's speaking speed detection, used word analysis, and dialect recognition through audio data, and can support more than 120 languages.

Natural language processing (NLP) can automatically process language and expression analysis regarding words and sentences of an interviewee, and can perform positive and negative semantic analysis.

Face detection can analyze facial expressions and eye tremors through the recognition of the facial muscles of an interviewee, and can detect the tension level of the interviewee by detecting subtle changes in his or her skin tone.

The core functions of the personal version services (for an interviewee) according to the present invention described above are as follows:

\textcircled{1} Interview practice skills are improved through AI analysis and job-specific questions.

\textcircled{2} An interview may be taken conveniently in the state of being free from temporal and spatial constraints, which are the problems of the existing face-to-face interview.

\textcircled{3} When a registration is made for an interview, a company may offer an additional job opportunity through the offer of an interview.

In addition, the core functions of the company version services (for an interviewer) according to the present invention are as follows:

\textcircled{1} An interview video of an applicant is analyzed using algorithms such as AI image and speech analysis algorithms.

\textcircled{2} A job-specific interview question template that can be referenced or utilized when interview questions are planned is provided.

\textcircled{3} The function of tracking applicants throughout an overall recruitment process, including a job posting, the conduct of interviews, the arrangement of an address book, and the sharing of interview results, is provided.

\textcircled{4} Tests specialized for a job group for which hard skills are important, including developers, content producers, designers, etc., are conducted.

In other words, the services of the present invention may be classified and then provided, as shown in the attached FIG. 11.

### Artificial Intelligence (AI) Interview Scoring

Images, voices, attitudes, etc. in the interview video of the applicants are analyzed through the specialized algorithm of the present invention, and AI analysis reports are provided.

### AI Interview Question Template

A customized questionnaire for each job and each applicant may be constructed by referring to the question template of the present invention.

### Applicant Tracking System

The function of the integrated management of applicants is provided throughout an overall recruitment process, including a job posting, an interview process, an address book, and the notification of results.

### Hard Skillset Test

There are provided questioners specialized for a professional job group requiring hard skills, including developers, content producers, and designers.

FIG. 12 shows views illustrating examples of AI-based non-face-to-face recruitment platform images for an interviewee and an interviewer.

As shown in the drawing, the AI-based non-face-to-face recruitment platform for an interviewee and an interviewer may provide services in the form of WEB and Native APP. The platform images may be provided in the form of a main page, splash, a login screen page, and a slide banner.

Recently, in preparation for the post-corona era, the demand for non-face-to-face (contactless) tools is rapidly increasing. Accordingly, it is necessary to secure young users in their 20s and 30s through the advancement of non-face-to-face simulated interview app functions. In addition, effective job competency verification may be performed in a contactless manner, and the interviewer's satisfaction is also increased as the applicant's non-attendance rate is lowered.

In particular, the AI-based non-face-to-face recruitment platform may be applied to the human resource (HR) field using artificial intelligence technology. In other words, when training for an interview is conducted through a simulated interview, an interviewee's confidence may be increased and interview performance may also be improved. Furthermore, as artificial intelligence technology is applied to the HR field, the number of cases of using it for recruitment is increasing. Recently, the use of artificial intelligence technology is increasing to support recruitment and HR departments.

In addition, the transition to the digital era, including the 4th industrial revolution, digital transformation, and the introduction of artificial intelligence (AI), is rapidly accelerating. Many experts predict that these changes will completely change people's work and business administration. More specifically, this prospect includes not only positive aspects such as technological innovation, improved productivity, and the emergence of new business opportunities, but also negative aspects such as a problem in which artificial intelligence or machines completely displacing human jobs. Accordingly, companies are competing to introduce new technologies due to a pressing situation in which they will become obsolete if they do not adapt to these changes. In this context, the present invention aims to present a talent management plan that can effectively cope with the changes that the introduction of artificial intelligence will bring to a company. To this end, the present invention presents the company's business strategy in the relationship between artificial intelligence technology and human labor as an artificial intelligence utilization strategy.

In addition, the perception of job applicants about selection process is a considerably important factor not only for the individual applicants but also for a corresponding organization. It is found that job applicants who experience unfairness or are dissatisfied with a selection process feel less attracted to a corresponding organization, develop a sense of antipathy towards the company, and have lower job-related efficacy. Job applicants having a negative perception of a selection process may file a legal lawsuit, lower the intention of other potential applicants, and are more likely to reject a job even when they are selected. In this case, it becomes difficult for an organization to select the desired talent, which leads to loss of costs for the organization. In order to allow job applicants to recognize an organization as attractive without feeling dissatisfied during a selection process and to accept the results of selection well, it is required that a reliable evaluator conducts selection through a fair process. As described above, the perception of job applicants about a selection process is important from selection significantly an organization's point of view. It is necessary to know whether artificial intelligence participates in a personnel selection process and whether job applicants are more satisfied with an artificial intelligence selection process than with a human recruitment process or perceive the artificial intelligence selection process as being fairer than the human recruitment process.

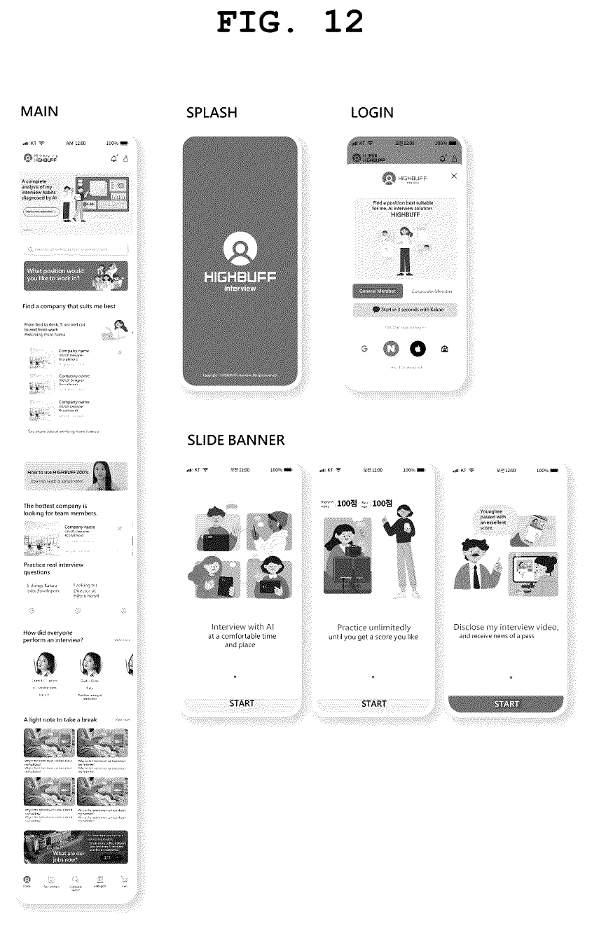

FIG. 13 is a diagram illustrating a client-server configuration for non-face-to-face customized talent sourcing through artificial intelligence analysis, and FIG. 14 is a diagram illustrating an example of an interface configuration for non-face-to-face customized talent sourcing service.

As shown in the drawing, a server contains a talent pool database, and the talent pool database stores job advertising data, applicant information, interview data, and artificial intelligence (AI) report information received from clients.

In the interview module of a client, an STT/TTS system may process an interviewee's speaking speed detection, used word analysis, and dialect recognition through audio data in real time, and supports more than 120 languages. In addition, language analysis and expression such as words and sentences may be automatically processed by natural language processing (NLP), and positive and negative semantic analysis may be performed. In addition, facial expression analysis and eye tremors may be analyzed through the recognition of the facial muscles of an interviewer. The tension level of the interviewer may be determined by detecting subtle changes in his or her skin tone.

An AI scoring module measures AI interview scores by learning interviewer patterns from various viewpoints similar to those of actual interviews and combining results from these viewpoints. In this manner, scoring is made more identical to that of actual interviews by diversifying data processing methods. In other words, in order to predict interview scores in the same way as in actual interviews, weights are allocated to a necessary aptitude for a job and appropriate interviewer's score. Furthermore, weights are also allocated to the evaluation values that fit a view on talent desirable for a company, so that a final output value is adjusted to approximate an evaluation value given by a person. The suitability of an interviewee for a job is determined based on an AI scoring result.

A prediction/analysis module generates additional questions capable of allowing interaction with an interviewee by checking the content of the interviewee's real-time interview and analyzing it through an STT technique. In this manner, interactive questioning is performed and the interview is managed.

Moreover, the character and inclination of an interviewer for a position and a job are checked through the personality type test of the interviewer, so that a suitable job can be recommended or the company can determined a suitable job.

In addition, documents are sorted according to passing or ranking by tracking the text of resumes and filtering and weighting according to the specifications desired by the company through AI. In this case, resumes having low scores through artificial intelligence (AI) may be verified separately by a personnel manager to compensate for the shortcomings.

The video interviews of applicants are analyzed using algorithms such as artificial intelligence image recognition and speech analysis algorithms, and a job-specific interview question template that can be referenced or utilized when video interview questions are planned is provided. In particular, tests specialized for a job group for which hard skills are important, including developers, content producers, designers, etc., are conducted.

In other words, according to the non-face-to-face customized talent sourcing method through artificial intelligence analysis according to the present invention, the skills and history of each applicant applied for a job posting are analyzed, processed, visualized, and then provided, and the applicant makes an artificial intelligence interview. In this case, documents are sorted according to passing or ranking by tracking the text of resumes and filtering and weighting according to the specifications desired by the company through AI. A job-specific interview question template that can be referenced or utilized when video interview questions are planned is provided, and tests specialized for a job group for which hard skills are important, including developers, content producers, designers, etc., are conducted.

Thereafter, the interview videos of the applicants are analyzed using artificial intelligence image and speech analysis algorithms, and the AI interview scores of the applicants are measured. In this case, additional questions that can interact with the applicants are generated by analyzing the content of the applicants' real-time interviews through voice recognition. Furthermore, audio data is processed and analyzed in real time through the applicants' speaking speed detection, used word analysis, and dialect recognition, language analysis including words and sentences and positive and negative semantic analysis are performed in in the interview videos of the applicants, facial expressions and eye tremors are analyzed through the recognition of the facial muscles of the applicants, and the tension levels of the applicants are determined by detecting subtle changes in skin tone. Additionally, in a manner similar to that of actual interviews, AI interview scores are measured by combining the results of patterns learning interviewer from various viewpoints. In order to predict interview scores in the same manner as those of actual interviews, weights are allocated to the necessary aptitude for the job, an appropriate interviewer's score, and an evaluation value that fits the view of talent of the company.

Thereafter, AI analysis reports are provided by analyzing images, voices, and attitudes in the interview videos of the applicants.

Thereafter, throughout an overall recruitment process including job postings, the conduct of interviews, an address book, and the notification of interview results, the applicants are tracked and managed in an integrated manner.

According to the AI interview and recruitment service method of the present invention described above, an employment discrimination problem may be solved due to the expansion of AI recruitment. With the recent expansion of the use of artificial intelligence in labor relationships, the use of artificial intelligence in a recruitment process may avoid unfairness caused by human bias and subjectivity.

In addition, the recruiting administrator of a company may perform a recruitment task more rapidly and easily, and may recruit talent based on a larger amount of data by objectifying the parts that previously had to rely on subjective judgment. For example, although an average of about 250 applicants apply for one job posting and it takes a lot of time and money to process collected recruitment data, an interview process equipped with an NLP engine and an AI filtering screening function may rapidly analyze and process the hard skills and histories of the applicants compared to a recruiting administrator, and may visualize and provide the results of the analysis and the process. When AI technology is used in document screening for a primary interview, it is easy to identify cheating such as plagiarism, and it is possible to analyze the self-introductions of more than tens of thousands of applicants in only one day. In particular, in a native app-based interviewee service, an application is installed on an individual's smartphone, so that the speed is rapid and stable, with the result that it is possible to have a smooth interview anywhere regardless of time. Additionally, a native app-based interviewer service optimized for each OS may have the right to easily access smartphones. Accordingly, individual recruitment processes may be easily managed by smoothly using the unique functions of smartphones such as calendar, address book, and camera functions.

As a result, experts required for companies can be efficiently recruited, thereby allowing the companies to focus on their core business. In other words, numerous application documents for companies can be screened in a consistent and manner, the diversity of talent pools in which objective companies are interested can be considerably expanded in a talent recruitment and selection process, and talented people with excellent competencies can be recruited.

According to embodiments, interview practice skills can be improved through the analysis of artificial intelligence and the provision of job-specific questions, and an additional job opportunity can be provided through the offer of an interview when a registration is made for an interview.

In addition, the function of tracking applicants throughout an overall recruitment process, including job postings, the conduct of interviews, the arrangement of address books, and the sharing of interview results can be provided, and customized talent suitable for the positions can be recruited in a non-face-to-face manner by conducting tests specialized for a corresponding job group, for which hard skills are important, including developers, content producers, and designers.

Although the specific embodiments have been disclosed for illustrative purposes, those skilled in the art will appreciate that various modifications, additions and substitutions are possible without departing from the scope and spirit of the invention as disclosed in the accompanying claims.

What is claimed is:

1. An artificial intelligence-based professional human resource platform service method, comprising:
analyzing and processing skills and history of an applicant who applies for a job posting, and then visualizing and providing results of the analysis and the processing;
conducting an artificial intelligence interview for the applicant;
analyzing an interview video of the applicant by using artificial intelligence (AI) image and speech analysis algorithms;
measuring an artificial intelligence interview score of the applicant; and
providing an artificial intelligence analysis report by analyzing images, voices, and attitudes in the interview video of the applicant.

2. The artificial intelligence-based professional human resource platform service method of claim 1, wherein analyzing and processing the skills and the history and then visualizing and providing the results of the analysis and the processing comprises:
determining whether a document has passed or sorting the document according to its rank by tracking a text of a resume of the applicant and then performing filtering and weighting according to specifications desired by a company through artificial intelligence.

3. The artificial intelligence-based professional human resource platform service method of claim 1, wherein conducting the artificial intelligence interview comprises:
providing a job-specific interview question template that can be referenced or utilized for the interview questions.

4. The artificial intelligence-based professional human resource platform service method of claim 1, wherein analyzing the interview video of the applicant comprises:
constructing additional interactive questions by analyzing real-time interview content of the applicant through voice recognition.

5. The artificial intelligence-based professional human resource platform service method of claim 1, wherein analyzing the interview video of the applicant comprises:
processing and analyzing audio data in real time by performing speaking speed detection, used word analysis, and dialect recognition for the applicant.

6. The artificial intelligence-based professional human resource platform service method of claim 1, wherein analyzing the interview video of the applicant comprises:
performing language analysis, including words and sentences, and positive and negative semantic analysis in the interview video of the applicant.
